(19) United States
(12) Patent Application Publication
(10) Pub. No.: US 2023/0067959 A1
(43) Pub. Date: Mar. 2, 2023

(54) HOT WATER PRESSURE WASHER

(71) Applicant: Ventech LLC, Wixom, MI (US)

(72) Inventors: Jeremy Sanger, Wixom, MI (US); Franco Garavoglia, Wixom, MI (US)

(73) Assignee: Ventech LLC, Wixom, MI (US)

(21) Appl. No.: 17/826,720

(22) Filed: May 27, 2022

Related U.S. Application Data
(63) Continuation-in-part of application No. 15/826,532, filed on Nov. 29, 2017, now abandoned.

(51) Int. Cl. B08B 3/02; F02B 63/06; F01P 5/04; F01P 3/20; F02D 41/00; F02B 63/02

(52) U.S. Cl. CPC B08B 3/026; F01P 3/20; F01P 5/04; F02B 63/02; F02B 63/06; F02D 41/0002; B08B 2203/007; B08B 2203/027; B08B 2203/0241; F01P 2005/046; F01P 2060/04

(57) ABSTRACT

A hot water pressure washer employs an internal combustion engine with a drive shaft having an exhaust manifold fluidly connected to an exhaust water heat exchanger. The engine is driveably connected to a hydrodynamic heater, and a high-pressure pump for generating a stream of high-pressure fluid. The hot water pressure washer captures 80-90% of the thermal energy generated during combustion processes of the engine for heating water.

### RELATED APPLICATIONS

This application is a continuation-in-part of U.S. Serial No.:15/826,532 entitled “Hot Water Pressure Washer” filed Nov. 29, 2017, which claimed priority to U.S. Provisional Application 62/427795 filed Nov. 29, 2016, which are incorporated by reference herein in their entireties.

### BACKGROUND

Portable pressure washers have been manufactured worldwide for residential and industrial uses. A pressure washer (also known as a power washer) is a high-pressure mechanical sprayer used to remove loose paint, mold, grime, dust, mud, and dirt from surfaces and objects such as buildings, vehicles and concrete surfaces. There are typically two versions of a portable pressure washer design; these being either cold water or hot water machines. The pressure washer may be connected to an existing water supply, such as a garden hose, or may store water in an attached tank. There may be an on/off switch for controlling the water stream and certain models may enable an operator to adjust the water pressure.

The configuration of a prior art hot water pressure washer may be more complicated than is a cold-water power washer. This may be due to a need to heat the incoming water to a substantial temperature and maintain that water temperature during use. For example, a hot water pressure washer may require typical water flow rates of 2 - 4 gallons per minute (GPM) and a required temperature rise more than 120-140° F. To achieve this, 40-80 kilowatts (kW) of thermal energy may be required on a continuous basis. The engine may be coupled to a high-pressure pump, either directly or via a drive mechanism, such as a serpentine belt. The pump is typically equipped with an unloader valve (i.e., pressure relief valve) that enables the user to adjust the output performance of the pressurized water stream (pressure and flow). An outlet port of the high-pressure pump may be plumbed to a flame-fired burner assembly. The burner assembly typically incorporates a continuous-coil air-to-water heat exchanger mounted over a gasoline or diesel-fired flame burner. The top of the burner may include an exhaust hood. A high-pressure hose may be attached to an output port of the burner assembly and terminated at a handheld ‘wand’ equipped with a trigger-release (i.e., hand valve) that permits the operator to control the flow (on or off) as desired. An inlet port of the high-pressure pump may be fitted with a hose hookup, typically for connection to a garden spigot.

Due to the complexity of the hot water pressure washer design versus a cold-water pressure washer, the cost of the hot water pressure washer is typically much higher than the cost for a cold water pressure washer.

There are several issues concerning operation of a hot water pressure washer that have not been satisfactorily addressed in prior washers. Thermal efficiency is one such issue. During operation of an internal combustion engine, approximately 22-30% of energy derived from fuel is converted into propulsion. Approximately 28-45% of the energy derived from fuel is lost as exhaust heat and approximately 22-32% is lost from the cylinder head(s) in the form of engine cooling. A final 8-15% is lost as radiation, convection, mechanical parasitic losses, and unburnt fuel throughout the engine. Prior art hot water pressure washers are also very inefficient. Prior art hot water pressure washers only utilize the engine as a source of propulsion for distribution and pressurization of the water, at an efficiency of about 22-30%. The pressurized cold water is then fed into a flame-fired burner. The flame burner, often separately fueled, heats the water continuously, or in the alternative, requires a thermostatically controlled burner to heat the water intermittently to maintain a desired temperature. The combined energy efficiency of the engine and fuel-burner results in an overall system thermal efficiency of 50-60%.

It is an object of the embodiments disclosed herein to maximize the efficiency of the calorific energy of fuel entering the system (energy-in) versus the mechanical and thermal energy (energy-out) recovered and utilized for direct use by the operator. Such an embodiment provides a significant reduction in operational costs, reduced tailpipe emissions, and an overall simpler, more compact, and highly effective hot water pressure washer operating at 80-90% thermal efficiency.

It is a further object of the embodiments disclosed herein to utilize thermal and mechanically generated energy from an internal combustion engine as the sole source of thermal energy for heating water without the need for increased engine size or the need for auxiliary heating units to heat water, such as a separately fueled flame-burner.

In the disclosed embodiments, the majority of converted energy leaving the engine is efficiently captured and combined for heating the water. The air-convection of heat from the various system components such as the internal combustion engine, high-pressure pump, plumbing and other components, is captured in a controlled air stream within and through an enclosure of the apparatus and directed into an air-to-water heat exchanger for extraction and conversion into heated water.

### SUMMARY

In one embodiment, there is disclosed a hot water pressure washer that employs a high-pressure pump for producing a stream of pressurized water. The hot water pressure washer includes an enclosure (housing) that encompasses all components of the pressure washer, including, but not limited to an internal combustion engine having an oil cooler, an air/water heat exchanger, an exhaust gas heat exchanger and a hydrodynamic heater for heating the water. The system further includes a high-pressure pump with an unloader valve, and a manually operated restrictor valve, such as a hand-held wand with a trigger to control the flow of water through the wand. The system may further include an engine throttle controller configured to idle the engine when the unloader valve is bypassed.

An internal combustion engine may be used to generate rotational torque for powering the high-pressure pump and the hydrodynamic heater and thereby inducing load onto the engine. This propulsion energy accounts for approximately 22-30% of the energy used by the engine and it is understood that a portion of the propulsion energy is converted to thermal energy by the rotational torque applied to the hydrodynamic heater. Heat is also generated in the engine as the load increases and the combustion heat of the engine is captured in several pathways. Combustion heat is partly transferred to engine oil. The engine oil passes through an inlet and outlet of an oil cooler. The oil heat may be transferred by an oil/air heat exchanger. This heat is carried in a hot airstream that is fluidly connected to an air/water heat exchanger. From there the heat is transferred to the entering water from the outside source. The thermal energy captured by the air/water heat exchanger is approximately 22-32% of the thermal energy available for heating water.

The water exits from the air/water heat exchanger through an outlet port to an inlet port on a hydrodynamic heater. The hydrodynamic heater adds more thermal energy to the water as it is subjected to rotational torque. The heat is transferred to the water flowing through the shear created by the hydrodynamic heater. The water in the hydrodynamic heater exits from an outlet port and flows through an inlet port on the exhaust/water heat exchanger.

The exhaust from the loaded engine generates heat that is captured by the exhaust/water heat exchanger, also used for water heating. The thermal energy converted by the hydrodynamic heater is approximately 23% of the thermal energy available for heating water. Water exiting the hydrodynamic heater enters the exhaust/water heat exchanger through a conduit at an inlet port and exits from an outlet port through a conduit to an inlet port on the high-pressure pump. The thermal energy captured from the exhaust is approximately 35% of the thermal energy available for heating water.

In one embodiment, the thermal energy is transported in the hot water pressure washer by a directional water flow pathway extending from an outside water source to an inlet port in an air/water heat exchanger. The engine exhaust heat is transferred to the water in the exhaust/water heat exchanger pathway and passes through an outlet port to an inlet port on the high-pressure pump with an unloader valve. The unloader valve may have a first outlet port fluidly connected to the inlet port of the air/water heat exchanger and a second outlet port fluidly connectable to a high-pressure hose. A handheld wand may be attached to a high-pressure hose and include a trigger activated hand valve that may be selectively actuated by an operator to control a stream of water discharged from the handheld wand. The unloader valve may be adjusted to control distribution of the high-pressure water discharged from the high-pressure pump between the bypass passage and the high-pressure hose.

The directional flow of water through the components of the hot water pressure washer is important to the functionality of the washer. It is also important to apply optimal load on the engine to drive thermal efficiency of the system. The engine may be loaded by the hydrodynamic heater and the high-pressure pump. Water, such as from a spigot, may be introduced though an inlet fluidly connected to the air/water heat exchanger. The air/water heat exchanger is fluidly connected to an inlet port of the hydrodynamic heater where water passes through an outlet port in fluid communication with an inlet port on an exhaust/water heat exchanger. The exhaust/water heat exchanger has an outlet port fluidly connected at an inlet port of a high-pressure pump. The hydraulic pump has an outlet port fluidly connected with an inlet port on an unloader valve. The unloader valve has an outlet port fluidly connected to a restrictor valve, which may be a manually operated hand wand. Without being bound to any single theory, it is believed the surprising results of increased thermal efficiency achieved by the embodiments of the instant disclosure are made possible by the direction of water flow through the various components, beginning with the introduction of water to the air/water heat exchanger and the water’s flow through the various components of the washer. Optimally, the system may be surrounded by a housing to direct heat loss radiating from the engine during operation and facilitate thermal energy transfer to the water moving through the washer. In other embodiments, the engine is covered by a shroud that permits air to flow between the shroud and the engine to direct the flow of air through the system to capture the energy radiated from the engine. Other embodiments include an engine throttle (such as a pressure switch) set to idle when the unloader valve is bypassing the water back through the system whenever the operator does not activate the wand. Other embodiments may further include a calibrated water chamber positioned prior to the air/water heat exchanger and/or a thermostatically or a electric controlled fan in the air/water heat exchanger to tune the energy balance of the system at engine idle. In other embodiments, the exhaust/water heat exchanger may be positioned after the high-pressure pump but before the unloader valve. The fan may be electrically connected to a power source, such as a battery or an engine dynamo like an alternator or generator.

The embodiments as described capture substantially 80-90% of available thermal energy from the engine during operation so thermal energy from the engine exhaust, engine cylinder head(s), oil cooler, and the hydrodynamic heater are used to heat water. This permits the internal combustion engine to be the sole source of thermal energy for a hot water pressure washer.

### BRIEF DESCRIPTION OF THE DRAWINGS

FIG. 1. cutaway side view of one embodiment of the hot water pressure washer showing its general construction and extraction of radiated thermal energy;

FIG. 2 is a front view of the embodiment of FIG. 1 showing the structure of the housing with the aperture for air flow through the housing;

FIG. 3 is the cutaway view of FIG. 1 detailing other aspects of the embodiment;

FIG. 4 is a schematic of the hydraulic layout of one embodiment of the hot water pressure washer showing the transfer of thermal energy from various operations of the internal combustion engine;

FIG. 5 is a schematic of the hydraulic layout of another embodiment of the hot water pressure washer;

FIG. 6 is a schematic of the hydraulic layout of another embodiment of the hot water pressure washer;

FIG. 7 is a diagrammatic representation of the typical thermal balance and efficiency of an internal combustion engine;

FIG. 8 is a diagrammatic representation of the typical balance and efficiency of a hot water pressure washer of the prior art having a separately fueled burner;

FIG. 9 is a diagrammatic representation of the thermal balance and efficiency of the embodiments disclosed herein;

### DETAILED DESCRIPTION

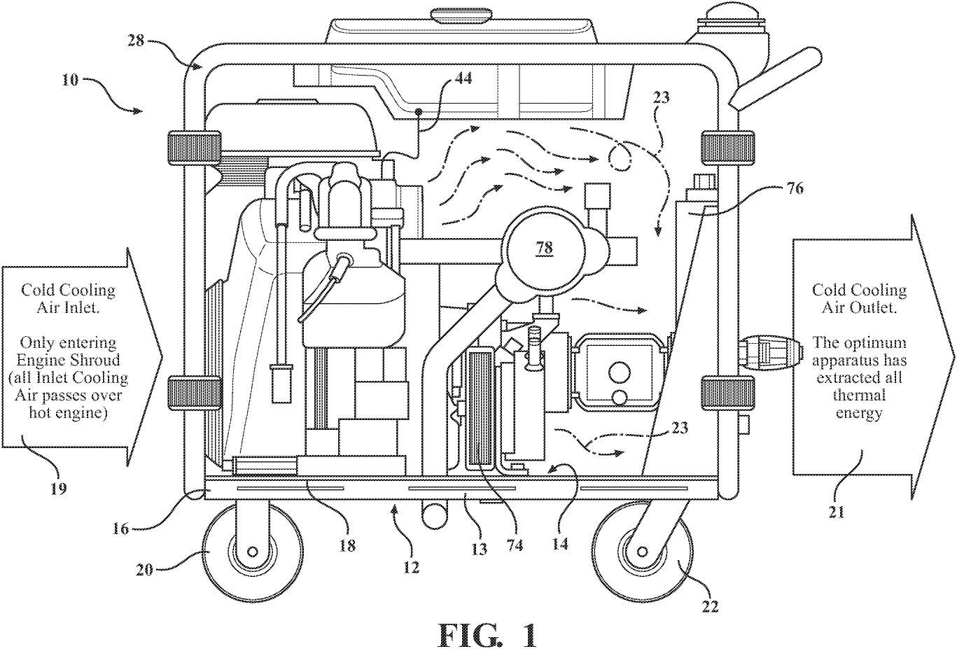

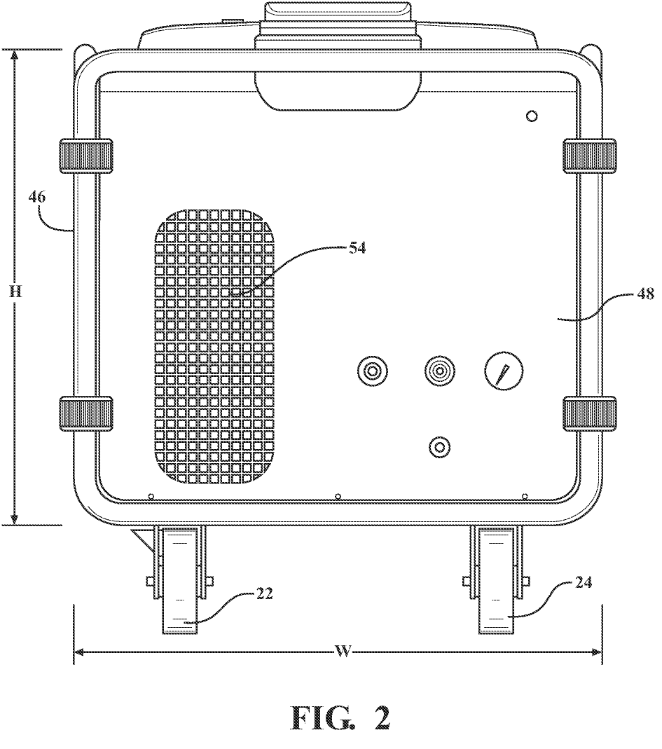

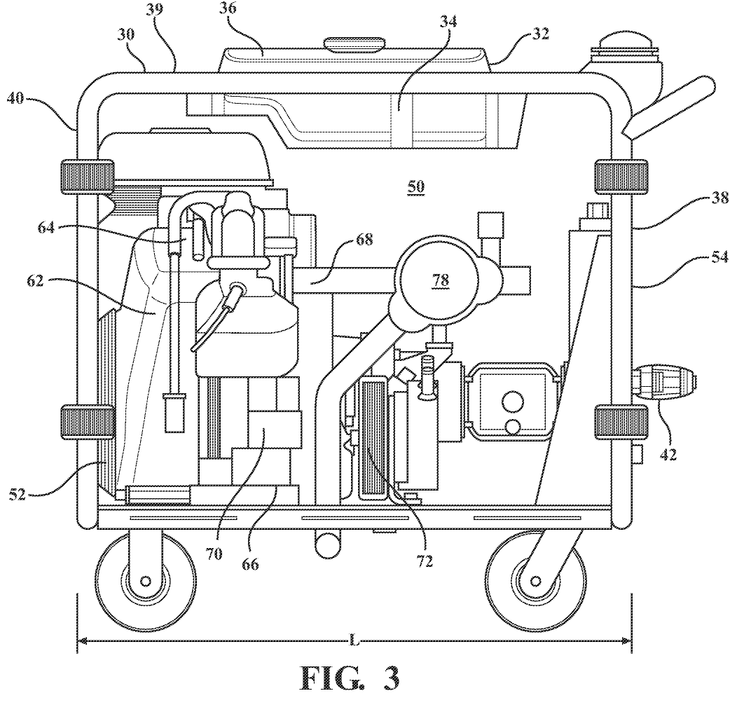

Turning now to the drawings wherein like numbers refer to like structures, and particularly FIGS. 1 through 6, there is shown a cutaway side view of one embodiment of the transportable high pressure hot water washer 10. The hot water pressure washer 10 is mounted upon a carrier 12 comprised of a platform 13 with an upper surface 14, sidewalls 16 and a bottom surface 18. The bottom surface has swivel wheels or rollers 20, 22, 24 and 26 place at each corner of the platform to facilitate easy movement of the hot water washer. Those skilled in the art understand that while swivel wheels 20-24 are shown, wheel 26 is positioned in spaced apart relationship and parallel to wheel 24.

A housing 28 covers the engine and/or is removably affixable to the carrier platform. The housing is comprised of a top surface 30 with a fuel tank aperture 32 and fuel tank supports 34 to support fuel tank 36 in position in the top surface of the housing. The fuel may be gasoline, diesel or natural gas or other suitable hydrocarbon fuel. The fuel tank is fluidly connected at 44 to the engine for supply of fuel thereto as it well known in the art. Opposed spaced apart front wall 38 and rear wall 40 are joined at their side edges to opposed spaced apart sidewalls 46 and 48. Each of the walls is joined with top panel 30 at their top edges to form a housing with an open bottom and an interior 50. In the embodiments as depicted, the housing has sufficient height H, width W and length L such that interior 50 accommodates the hot water pressure washer internal components. The housing is removably attachable to the carrier. Those skilled in the art recognize the housing may be formed in a single piece, as separate panels or as a modular structure. In addition, the housing may be a shroud on the engine through which air may flow to move radiated engine heat to the air/water heat exchanger.

The housing further includes an air inlet 52 and an air outlet 54. Incoming airflow 19 is drawn into the enclosure by thermostatically controlled and calibrated fan 136, where it passes over the hot engine. The airflow 19 passes over the engine and all internal components and exits the enclosure at outlet 54 as outgoing air 21 it passes over the air/heat exchanger and exits out of the air outlet. The flow of incoming air through the housing moves the heated air radiated 23 in the enclosure over the radiator and out of the enclosure. This air movement permits the hot water pressure washer to extract the heat radiated by the engine and heat water in a manner to be hereinafter described.

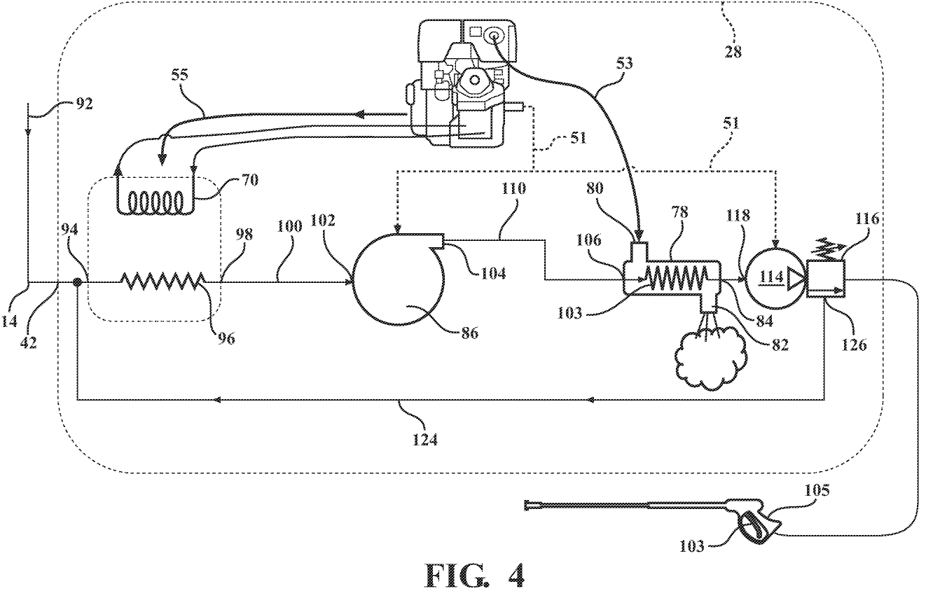

The hot water pressure washer components include an internal combustion engine 62 having an engine cylinder head 64, and engine block 66, an exhaust header 68, an oil cooler 70 and a drive shaft 72. The internal combustion engine is the sole source of thermal energy used to heat water for the described hot water pressure washers. The system further includes an air/water heat exchanger 96. If the engine is air-cooled, the airflow 19 passes over the air/water heat exchanger to warm water that is entering into the air/water heat exchanger from an outside source, such as a spigot 92 through hose coupling 42, where it passes through cold water inlet port 94 into the air/water heat exchanger. If the engine is water cooled, the air/water heat exchanger may be fluidly connected to the engine water jacket to dissipate heat from the engine cylinder head and the oil cooler. There is an accumulation of thermal energy carried by the water flow path that may be seen in FIG. 4. Water enters the hot water pressure washer through a cold water inlet port 94, passes through the air/water heat exchanger where the heat in the air/water heat exchanger is absorbed by the incoming water. The water then passes out of air/heat exchanger outlet port 98 through flow path 100, shown as a conduit, to water inlet port 102 on the hydrodynamic heater 86 where the engine provides rotational torsion to impart shear and heat the water. The heated water passes via hydrodynamic heater water outlet port 104 through flow path 110 to the exhaust/gas heat exchanger water inlet port 106. The engine provides exhaust gas through the manifold to the exhaust/water heat exchanger. The water circulates through flow path 108 (shown as a conduit) where the water is further heated by the exhaust gas. The heated water passes through the exhaust gas heat exchanger water outlet port 84 and into flow path 112. Flow path 112 passes the heated water through pressure pump water inlet port 118 and into pump 114. The operator may operate the unloader valve 116 by operating the restrictor valve 122, which may be fluidly connected to a hand held wand 105 with a trigger valve 103. Activating the restrictor valve permits a stream of hot pressurized water to be sprayed as desired. The flow path will be described in greater detail to further expand upon this brief overview as set forth here.

The exhaust/water heat exchanger 78 operates as a third source of thermal energy used to heat the water passing through the pressure washer. Although a suitably sized hydrodynamic heater may negate a need to employ an exhaust/water heat exchanger, it may be beneficial that hot water pressure washers as disclosed utilize the smallest displacement of internal combustion engine as possible, thereby greatly minimizing the system cost. Recovery of heat from the engine exhaust system is effectively “free” thermal energy to the system, thus providing a measurable benefit from incorporating exhaust/water heat exchanger. The exhaust/water heat exchanger 78 may be fluidly connected to an exhaust manifold 68 of the engine. Exhaust gas from the engine may enter the exhaust/water heat exchanger at an exhaust gas inlet port 80. The exhaust gas may pass through the exhaust/water heat exchanger and be discharged to the atmosphere through at exhaust output port 82. Heat passing from the internal combustion engine through exhaust/water heat exchanger 78 may be transferred to the water passing through water flow path 108 in the exhaust/water heat exchanger. Warmed water may be discharged from the exhaust/water heat exchanger at exhaust/water heat exchanger water outlet port 84 and into flow path 112.

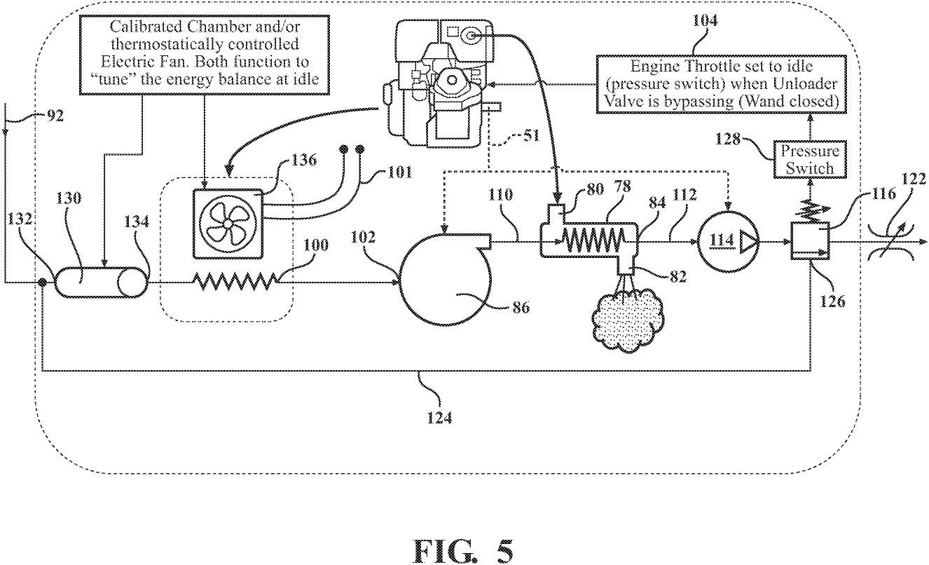

Generally, the prime mover (internal combustion engine) uses fuel (a hydrocarbon such as gasoline, diesel or natural gas) to generate the energy it outputs. It is well known that a given quantity of a hydrocarbon fuel produces a given amount of energy, known as Joules. A liter of gasoline has 31,536,000 joules of energy in it. A kilowatt-hour is equal to 3,600,000 joules. Therefore, a liter of gasoline has 8.76 kW/hr of energy in it. In FIGS. 4 and 5, rotational torque 51 is applied by the engine drive shaft 72 rotation to the hydrodynamic heater and the high pressure pump. This creates load on the engine and causes it to warm up. As the engine “warms up” more thermal energy is produced. The increased load thus created causes the exhaust gas 53 temperature to increase, which warms the water as it enters the exhaust/water heat exchanger 78. Finally, the increased load on the engine facilitates the combustion temperature in the head of the engine. The combustion chamber thermal energy 55 is transferred to the air/water heat exchanger by the airflow through the housing (or the shroud) to warm water as it enters the air/water heat exchanger from the spigot 92.

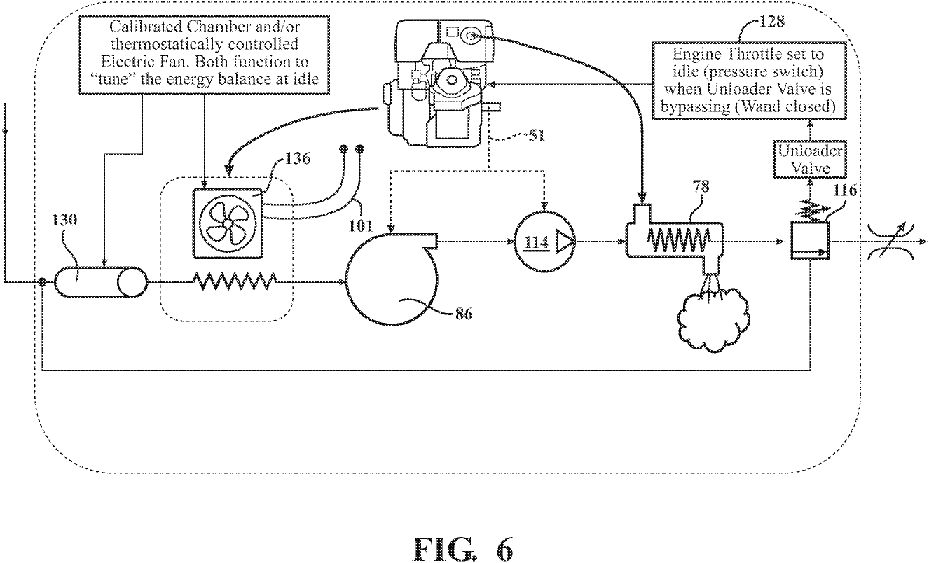

Turning to FIG. 6, the thermal efficiency of the gasoline engine operation causes about 22-30% of the energy to be produced as propulsion energy. An additional 28-45% of the energy produced is wasted as exhaust heat loses, and about 22-32% of the energy produced is expended as heat loss through an air/water heat exchanger. As will be described, the hot water pressure washers of this disclosure utilize the engine to create propulsion energy that is used to impart rotational torque to drive the hydrodynamic heater 86 and the high-pressure pump 114. This creates an increased load on the engine which increases engine operating temperature and causes more thermal energy to be sent via the exhaust manifold to the exhaust/water heat exchanger to heat the water in a manner as described. In addition, the thermal energy (heat) from the engine cylinder head causes the oil to become hot. The heat from the oil is transferred via the oil cooler 70 to the air/water heat exchanger via the air-flow 23 in the housing to cool the engine. The water in the air/water heat exchanger is heated by the movement of heated air over the air water heat exchanger. This heat warms the water as it initially enters the hot water pressure washer water flow pathway as will hereinafter be described. The systems as described are an improvement over prior art systems because each configuration produces increased engine load, recovers most of the heat losses from this increased engine load and exhaust gas heat losses for the purpose of heating the water in the system. Thus, the embodiments as described herein capture 80-90% of the thermal energy produced by the internal combustion engine to heat the water in the washer. This is advantageous because a smaller engine in the arrangement as described can now be used to produce the same thermal energy as prior art hot water washer systems that use larger engine, operating in conjunction with an external heater device, such as an flame-based burner heater. This is a substantial cost savings. In addition, the hot water pressure washers of this disclosure use an internal combustion engine as the sole source for thermal energy to heat the water, as opposed to prior art systems that utilize an auxiliary heater and storage tank.

The hydraulic layout of the system may be understood by reference to the FIGS. The water from the spigot 92 enters via an inlet port 94 to the air/water heat exchanger where it flows through air/water heat exchanger conduit 96 in the air/water heat exchanger. At least some of the heat in the air/water heat exchanger is transferred to the water in the conduit 96. The water exits the air/water heat exchanger conduit at an outlet port 98 where it passes through a conduit 100 to the inlet port 102 of a hydrodynamic heater 86. The hydrodynamic heater is actuated by the drive shaft 72 of the engine either directly, or via a serpentine belt 74, to rotate the hydrodynamic heater to produce torsional forces and impart shear to the water in the hydrodynamic heater. The pump 114 and the hydrodynamic heater 86 may be directly driven by the drive shaft, or may be driveably connected to the drive shaft 72 by the serpentine belt 74 as is known in the art. The shear forces impart additional thermal energy (heat) to the water. The water thus heated passes through the outlet port 104 of the hydrodynamic heater via conduit or flow path 110 and into the exhaust/water heat exchanger via exhaust/water heat exchanger inlet port106. The water is then further heated by the exhaust gas heat from the engine as it passes through the exhaust/water heat exchanger. The engine exhaust gas heats the water in a conduit 108 extending through the exhaust/water heat exchanger, and the exhaust gas exits the exhaust/water heat exchanger via exhaust outlet port 82. The heated water exits the exhaust/water heat exchanger outlet port 84 where it passes through a conduit 112 and enters the high-pressure pump 114 with unloader valve 116 through inlet port 118. The high-pressure pump is, through the unloader valve, fluidly connected to a restrictor valve 122, such as a manually operated hand held spray wand, where heat water may be manually disbursed as needed. A water recirculating bypass conduit 124 fluidly connects the unloader valve to the inlet port 94 so that whenever the sprayer is not activated, the heated water is recirculated through the system to ensure there is a ready supply of heated water available. Temporarily blocking the discharge of water from handheld wand, determined by the operator’s operation of the wand (and thereby the restrictor valve), enables the exhaust/water heat exchanger to substantially pre-heat the water as it continuously circulates through bypass outlet port 126 of unloading valve, through bypass flow 124 and then through the water inlet port of the air/heat exchanger, hydrodynamic heater (further preheating the water), exhaust/water heat exchanger, and high pressure pump. This ‘bypass loop’ may continue until the trigger valve 103 on the wand 105 is depressed to open the restrictor to allow water to discharge from handheld wand to atmosphere. When the water flow to the atmosphere is re-established by actuating a hand held wand, the unloader valve may cease or partially cease bypassing the water through bypass passage. The amount of bypass fluid may be determined by the operator’s manual adjustment of unloader valve through the wand.

Reference is made to another embodiment of the hot water pressure washer is depicted (see FIG. 6). Specifically, in this embodiment, the exhaust/water heat exchanger is positioned after the high pressure pump but before the unloader valve.

Optionally, the system may further be equipped with an engine throttle controller 104 set to idle when the unloader valve is bypassed (i.e., the wand is closed). In one embodiment, the engine throttle controller may be a pressure switch 128. In addition, the system may be further enhanced by a calibrated water chamber 130 fluidly connected with the water inlet port 94 via with inlet port 132 and, via outlet port 134, with air/water heat exchanger inlet port 94. The calibrated water chamber is located between the inlet port 94 and the air/water heat exchanger to store recirculated water from the bypass when unloader valve is closed. In addition, the system may further include an optional electrical powered 101 thermostatically controlled electric fan 136 in close proximity to the air/water heat exchanger to ensure the air/water heat exchanger dissipates heat to the water at a rate conducive to achieve constant high water temperature of the heated water in the system. The electric fan and the calibrated water chamber both function to “tune” the energy balance of the hot water pressure washer when the engine is at idle.

The hot water pressure washer individual components having been described, it is essential that these components are arranged in such a manner as to create a directional water flow pathway during operation. The water flow through the hot water washer may take two slightly different directional flow pathways. In one embodiment, and with reference to FIGS. 4 and 5, during operation, water from an outside source, such as a tap or spigot, enters the air/water heat exchanger through water inlet port 94. The water circulates through the conduit 96 and, after absorbing some thermal energy sent to the air/water heat exchanger from the combustion of fuel in the engine, the now warmed water exists through water outlet port 98 and travels through conduit or flow pathway 110 where it enters a hydrodynamic heater 86 at its water inlet port 102. As the water moves through the hydrodynamic heater, the prime driver (engine) subjects the hydrodynamic heater to rotational torsion, which imparts shear to the water moving through the hydrodynamic heater, further heating the water. The heated water exits the hydrodynamic heater at water outlet port 104, and moves through directional flow pathway or conduit 110, where it enters water inlet port 106 of exhaust/water heat exchanger 78 and travels through conduit or directional flow pathway 108 where the water is further heated by the thermal energy (heat) of the engine exhaust. The heated water exits the exhaust/water heat exchanger at water outlet port 84 and travels through conduit or direction flow pathway 112 until it enters high pressure pump 114 through water inlet port 118. The unloader valve may be actuated by an operator by a restrictor valve 122, which may be a hand held wand to spray water. If the operator does not operate the restrictor valve, the water may exit the pump and through water outlet port 126 and travel along bypass water flow pathway or conduit 124. Conduit 124 connects with the air/water heat exchanger at water inlet port 94 so that warm water may be circulating and remain heated at all time when the engine is operating. This feature gives the operator hot water on demand.

In another embodiment, the water flows along the same pathway as described above with the exception that the high-pressure pump is positioned in the water flow pathway before the water flows to the exhaust/water heat exchanger.

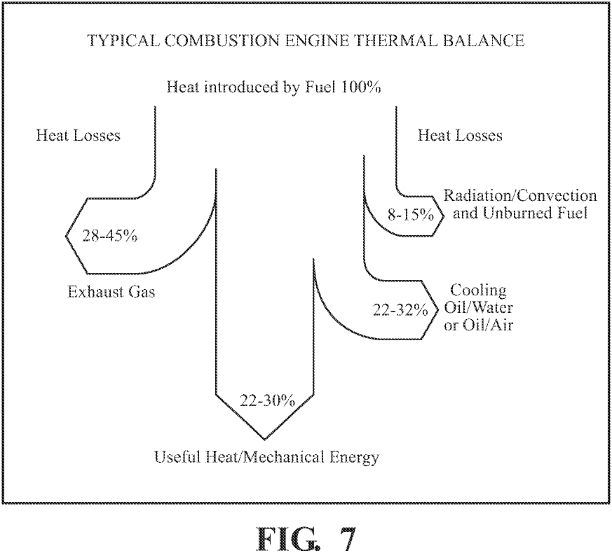

FIG. 7 is a diagrammatic representation of the useful heat that is retrieved from a typical combustion engine. Specifically, 100% of the heat from the engine is created by combustion of the introduced fuel. As is well understood, heat losses occur that can be quantified. Specifically, 28 - 45% of the thermal energy from the combustion process is lost as exhaust gas. From about 8-15% of the thermal energy from the combustion process is lost as radiation/convection and unburned or incompletely combusted fuel. Cooling of oil/water or oil/air accounts for 22-32% of the thermal energy from the combustion process. Accordingly, only about 22-30% of the thermal energy from the combustion process is useful heat/mechanical energy.

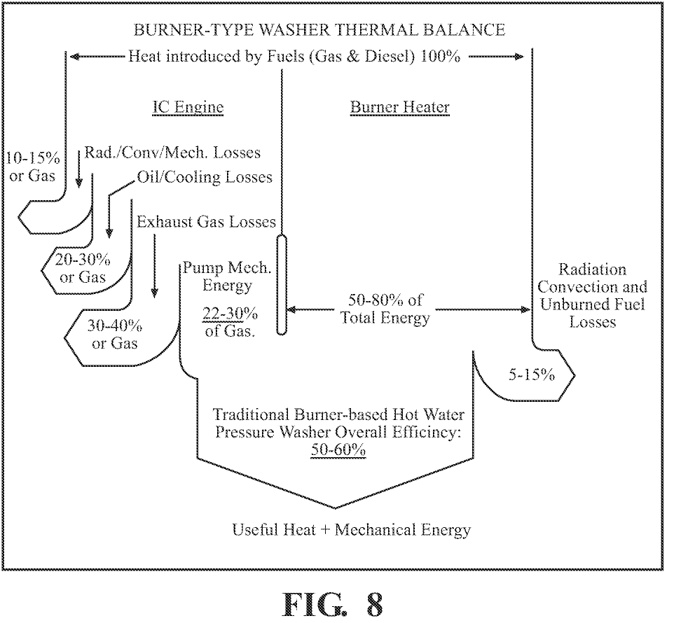

FIG. 8 is a diagrammatic representation of the thermal energy produced from a pressurized washer that uses an internal combustion engine to pump water, and a separate burner to heat the water. In FIG. 8, the internal combustion engine is powered by gasoline and the burner is powered by diesel. The thermal losses are shown in terms of the percentage of the fuel consumed for each thermal activity. For the internal combustion engine, the mechanical losses account for about 10-15% of the gasoline consumed. Oil/cooling losses account for about 20-30% of the gasoline combusted. Exhaust gas losses account for about 30-40% of the fuel consumed, leaving only 22-30% of the fuel consumed to provide mechanical energy to drive a pressure pump. The diesel fuel consumed by the burner represent about 50-80% of the total energy consumed by this type of water heater. The diesel burner loses about 5-15% of the fuel consumed as radiation convection and unburned heat loses. This type of water heater has a combined thermal efficiency (gasoline and diesel) of about 50-60%.

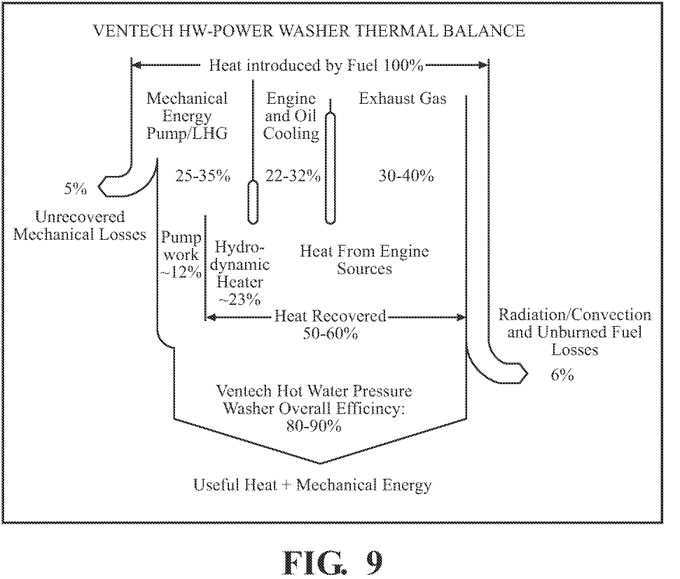

FIG. 9 is a diagrammatic representation of the thermal balance of the internal combustion engine powered hot water pressure washers as disclosed in this application. Specifically, about 5% of the thermal energy is lost through unrecovered mechanical loses. An additional approximate 6% is lost to radiation/convection and unburned fuel losses. What is significant is the amount of thermal energy that is available for heating the water. From about 25-35% of the thermal energy is mechanical energy to drive the hydrodynamic heater and high pressure pump. The pump takes about 12% of the thermal energy and the hydrodynamic heater takes about 23% of the thermal energy as mechanical energy. The engine and oil cooling takes about 22-32% of the thermal energy produced and the exhaust gas takes about 30-40% of the thermal energy produced. But these sources of thermal energy are, for the most part, recovered in the systems as described herein, such that in the hot water power washers as described, the overall thermal energy efficiency is about 80-90%. This is a significant and unexpected advantage over systems of the prior art.

The hot water washers as described are also much less expensive to operate for a given period of time. Table I shows some typical operating expenses over a 1-hour period of continuous spray.

Table I

| Parameter Description | Hot Water Pressure Washer | Burner-Type Traditional Hot Water Pressure Washer | |
|---|---|---|---|
| Fuel Type | Gasoline | Gasoline | Diesel |
| Fuels Lower Caloric Values - kJ/kg | 43500 | 43500 | 42000 |
| Fuels Specific Gravity - kg/l | 0.73 | 0.73 | 0.83 |
| Water Flow Rate -l/1' | 14.51 | | 14.51 |
| Water Temperature Rise - °C | 54.11 | NA | 54.11 |
| Heat Energy to Water - kW Spec. | 54.57 | | 54.57 |
| Fuel Consumption - kg/kWh | 0.28 | 0.28 | NA |
| Total Mechanical Power - kW | 28.20 | 10.81 | |
| Hydraulic Pump Power - kW | 10.81 | 10.81 | |
| Energy Source from Fuels kW | 95.4 | 36.58 | 77.95 |
| Mechanical Efficiency % | 29.6 | 29.56 | NA |
| Heat Conversion Efficiency % | 57.2 | | |
| | | NA | 70.0 |
| Total Fuel-to-Useful-Work Efficiency | 86.7% | 57.1 % | |
| Heat Recovery from Cooling % | 10.57 | NA | |
| Heat Recovery from LHG % | 16.40 | | |
| Heat Recovery from Exhaust % | 30.21 | | |
| Total Energy Consumption kW | 95.4 | 114.54 | |
| Hourly Fuel Consumption - l/h | 10.8 | 4.1 | 8.1 |
| Hourly Fuel Consumption - Gal/h | 2.9 | 1.1 | 2.1 |
| Fuel Price (Ml average 4/29/22) - $/Gal | 3.98 | 3.98 | 4.92 |
| * Application Hourly Fuel/s Cost | $ 11.37 | $ 14.82 | |

* Assumed cost for 1 hour of continuous spray NA = Non-Applicable

As can be seen, the hot water pressure washer of the instant application is far less expensive to operate and is more fuel efficient than the burner type traditional hot water pressure washer that uses a gasoline internal combustion engine to drive a pump and a diesel powered burner to heat water.

Referring generally to the entirety of above description and material incorporated by reference, the text and drawings shall be interpreted as illustrative rather than limiting. Changes in detail or structure may be made without departing from the present disclosure. Various embodiments are described above to provide a general understanding of the overall structure and function of the hot water pressure washer. Particular configurations, assemblies, or components and functions described with respect to one embodiment may be combined, in whole or in part, with those of other embodiments. Well-known operations, components, and elements such as simple attachment devices have not been described in detail so as not to obscure the embodiments described in the specification. While processes, systems, and methods may be described herein in connection with one or more steps in a particular sequence, such methods may be practiced with the steps in a different order, with certain steps performed simultaneously, with additional steps, and/or with certain described steps omitted.

It is intended that the scope of the present methods and apparatuses be defined by the following claims. However, it must be understood that the disclosed systems and methods may be practiced otherwise than is specifically explained and illustrated without departing from its spirit or scope. It should be understood by those skilled in the art that various alternatives to the configurations described herein may be employed in practicing the claims without departing from the spirit and scope as defined in the following claims. The scope of the disclosed systems and methods should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc., should be read to recite one or more of the indicated elements unless a claim recites an explicit limitation to the contrary. It is intended that the following claims define the scope of the device and that the method and apparatus within the scope of these claims and their equivalents be covered thereby. In sum, it should be understood that the device is capable of modification and variation and is limited only by the following claims.

I claim:

1. A hot water pressure washer, comprising:
an internal combustion engine including a drive shaft to create rotational torque; said engine including an engine idle throttle control; and an exhaust manifold; an exhaust/water heat exchanger fluidly connected to said engine manifold; said internal combustion engine fluidly connected to a fuel source;
a hydrodynamic heater operably connected to the internal combustion engine; said internal combustion engine having a drive shaft to impart rotational torque; said hydrodynamic heater driveably connected to said drive shaft and powered by rotational torque to create load on said engine; said hydrodynamic heater including a water inlet port and a water outlet port;
a high pressure pump operably connected to the internal combustion engine; said high pressure pump powered by said rotational torque to create load upon said engine; said high pressure pump including a water inlet port and a water outlet port;
an air/water heat exchanger having a water inlet port connectable to a water source and a water outlet port fluidly connected to the water inlet port of the hydrodynamic heater;
a water flow pathway to facilitate directional water movement from said air/water heat exchanger water inlet, through said air/water heat exchanger and through the air/water heat exchanger water outlet port to said hydrodynamic heater water inlet port, through the hydrodynamic heater, through the hydrodynamic water outlet port to a water inlet port on said exhaust/water heat exchanger, through said exhaust/water heat exchanger, through an exhaust/water heat exchanger water outlet port to the water inlet port on the high pressure pump; through the high pressure pump to the high pressure pump water outlet port to a water inlet port on an unloader valve to a water outlet port on the unloader valve responsive to a manually operated restrictor valve.

2. The hot water pressure washer of claim 1, further including a bypass recirculation fluid flow pathway extending from a second water outlet port on the unloader valve to the air/water heat exchanger water inlet port.

3. The hot water pressure washer of claim 2, further including a calibrated fluid chamber having a water inlet port fluidly connected to said bypass recirculation fluid flow pathway and a water outlet port fluidly connected to said air/heat exchanger inlet port.

4. The hot water pressure washer of claim 1, wherein the engine throttle is set to idle when the unloader valve is in bypass mode.

5. The hot water pressure washer of claim 4, wherein the engine throttle is set to idle by a pressure switch.

6. The hot water pressure of claim 1, further including a housing having a top wall joined at opposed ends to opposed spaced apart front and rear walls joined with opposing spaced apart side walls to form an enclosure with an interior, said interior having a length L and a width W and a height H to define an interior; said interior enclosing the hot water pressure washer.

7. The hot water pressure washer of claim 1, further including a carrier platform; said carrier platform having a top surface, a bottom surface and a sidewall extending substantially unbroken therebetween; said carrier equipped with wheels mounted on said bottom surface; said engine mounted on said carrier platform.

8. The hot water pressure washer of claim 6, wherein the top wall includes an aperture to accommodate a fuel tank; said fuel tank fluidly connected to said engine.

9. The hot water pressure washer of claim 1, further including a thermostatically controlled electric cooling fan to move air over the engine; said fan electrically connected to a power source.

10. The hot water pressure washer of claim 1, wherein said unloader valve has a water inlet port fluidly connected to the water outlet port of the high-pressure pump and a water outlet port fluidly connected to a water inlet port on the air/water heat exchanger.

11. The hot water pressure washer of claim 10, wherein the unloader valve further includes a second outlet port fluidly connectable to a handheld wand.

12. A hot water pressure washer, comprising:
an internal combustion engine including a drive shaft to create rotational torque; said engine including an engine idle throttle control; an exhaust manifold; an Exhaust/Water Heat Exchanger fluidly connected to said engine manifold;
a hydrodynamic heater operably connected to the internal combustion engine drive shaft; said hydrodynamic heater powered by said rotational torque to create load on said internal combustion engine; said hydrodynamic heater including a water inlet port and a water outlet port;
a high pressure pump operably connected to the internal combustion engine drive shaft; said high pressure pump powered by said rotational torque to create load upon said engine; said High Pressure Pump including a water inlet port and a water outlet port;
an unloader valve having a water inlet port fluidly connected to said high pressure pump water outlet port; said unloader valve further equipped with a water outlet port;
an air/water heat exchanger having a water inlet port connectable to a water source; said air/water heat exchanger having a water outlet port fluidly connected to the water inlet port of the hydrodynamic heater;
an engine oil cooler having an oil inlet port fluidly connected to the internal combustion engine; an oil outlet port fluidly connected to the internal combustion engine; and
a water flow pathway to facilitate directional water movement from said air/water heat exchanger inlet, through said air/water heat exchanger and through its water outlet port to said hydrodynamic heater inlet port; through the hydrodynamic heater and to the hydrodynamic heater water outlet port; through the hydrodynamic heater water outlet port to the high pressure pump water inlet port; through the high pressure pump to the high pressure pump water outlet port; through the high pressure pump water outlet port to a water inlet port said exhaust/water heat exchanger; through said exhaust/water heat exchanger; through the exhaust/water heat exchanger water outlet port to the water inlet port on said unloader valve; through the unloader valve and through a water outlet port on said unloader valve responsive to a manually operated restrictor valve.

13. The hot water pressure washer of claim 12, further including a bypass recirculation water flow extending from a second water flow outlet port on said unloader valve to said air/water heat exchanger water inlet port.

14. The hot water pressure washer of claim 12, wherein the engine throttle is set to idle when the unloader valve is in bypass mode.

15. The hot water pressure washer of claim 12, wherein a calibrated fluid chamber having a water inlet port and a water outlet port, said calibrated chamber fluidly connected at its water outlet port to the water inlet port of the air/water heat exchanger.

16. The hot water pressure washer of claim 12, further including a housing having a top joined at opposed ends to opposed spaced apart front and back walls joined with opposing spaced apart side walls to form an enclosure with an interior, said interior having a length L and a width W and a height H of sufficient size to enclose the hot water pressure washer within the housing interior.

17. The hot water pressure washer of claim 12, wherein the top wall includes an aperture to accommodate a fuel tank; said fuel tank fluidly connected to said engine.

18. The hot water pressure washer of claim 12, wherein the engine throttle is set to idle by a pressure switch.

19. The hot water pressure washer of claim 12, further including a thermostatically controlled electric cooling fan to move air over the engine; said fan electrically connected to a power source.
